(19) United States
(12) Patent Application Publication
(10) Pub. No.: US 2022/0226179 A1
(43) Pub. Date: Jul. 21, 2022

(54) APPARATUSES AND METHODS FOR PROVIDING AN ISOLATION AREA AROUND AN INDIVIDUAL

(71) Applicants: Michael Carnahan, West Lafayette, IN (US); Afshin Zahraee, Chicago, IL (US)

(72) Inventors: Michael Carnahan, West Lafayette, IN (US); Afshin Zahraee, Chicago, IL (US)

(21) Appl. No.: 17/578,120

(22) Filed: Jan. 18, 2022

Related U.S. Application Data
(60) Provisional application No. 63/138,686, filed on Jan. 18, 2021.

(51) Int. Cl. A61G 10/00; A61G 5/10; E04H 1/12

(52) U.S. Cl. CPC A61G 10/005; E04H 1/125; A61G 5/1094

(57) ABSTRACT

Apparatuses and methods for defining an isolation area around an individual. Such an apparatus includes a frame having two opposing and spaced-apart side walls, an interior region within an interior of the apparatus and defined by and between the side walls, and one or more connecting members spanning the interior region and coupling the opposing side walls. Isolation barriers are coupled to the frame and extend outwardly from the interior region. The isolation barriers are configured to define an isolation zone surrounding the interior region that corresponds with the isolation area around an individual located within the interior region. An opening is providing for access by the individual to and from the interior region within the frame.

### CROSS-REFERENCE TO RELATED APPLICATIONS

This application claims the benefit of U.S. Provisional Application No. 63/138,686 filed Jan. 18, 2021, the contents of which are incorporated herein by reference.

### BACKGROUND OF THE INVENTION

The present invention generally relates to the care and treatment of patients under contact isolation. The invention particularly relates to apparatuses configured to provide a physical barrier around an individual that defines an isolation area corresponding to a medical recommendation related to transmission of infectious agents to or from the individual.

The earliest years of a person's life are believed to be of great importance to their overall development. When children between ages zero and three years old are isolated in a hospital room due to an illness, the rate at which they develop can be negatively impacted. Commonly, children with whom contact is limited or restricted due to a weakened immune system (“contact-isolated” children) are unable to leave their rooms or play with other patients because of an increased chance of contracting an illness. According to the Center for Disease Control (CDC), under generally normal conditions contact-isolated children can come out of their rooms if a three-foot radius of isolation is maintained around the child. The only way to enter the three-foot radius without significantly increasing the risk of spreading illness is when the individual is wearing protective gear, such as a gown, mask, and gloves to prevent passing an infection to anyone else. Research suggests that children in contact isolation would greatly benefit from interactions with environments outside of their hospital rooms and/or with other individuals and that such interactions may enhance their social development and overcome challenges presented by their illnesses.

Unfortunately, methods of enabling contact-isolated children to have these desirable interactions have been limited. One method that has been used includes taping off an area of the hospital and transporting the child there. The purpose of the tape is to mark out a visible barrier such that others know not to come excessively close to the child. This method is not ideal since the child must remain within the taped off area and therefore is extremely limited in exploring their surroundings. Furthermore, a visible barrier is not present around the child during transportation between their hospital room and the taped off area.

Accordingly, it would be beneficial if methods were available that were capable of assisting contact-isolated children or other individuals in leaving their hospital rooms while maintaining a visible barrier about them representative of a medically-recommended isolation area.

### BRIEF DESCRIPTION OF THE INVENTION

The present invention provides apparatuses and methods of assisting contact-isolated children or other individuals to leave their hospital rooms (or other living space) while maintaining a visible barrier about them representative of a medically-recommended isolation area.

According to one aspect of the invention, an apparatus is provided that is configured to define an isolation area around an individual. The apparatus includes a frame having two opposing and spaced-apart side walls, an interior region within an interior of the apparatus and defined by and between the side walls, and one or more connecting members spanning the interior region and coupling the opposing side walls. Isolation barriers are coupled to the frame and extend outwardly from the interior region. The isolation barriers are configured to define an isolation zone surrounding the interior region that corresponds with the isolation area around an individual located within the interior region. An opening is providing for access by the individual to and from the interior region within the frame.

According to another aspect of the invention, a method is provided for defining an isolation area around an individual based on a medical recommendation related to transmission of pathogens to or from the individual. The method includes providing an apparatus comprising a frame having two opposing and spaced-apart side walls, an interior region within an interior of the apparatus and defined by and between the side walls, one or more connecting members spanning the interior region and coupling the opposing side walls, and isolation barriers coupled to the frame and extending outwardly from the interior region, and then locating the individual in the interior region within the frame so that the isolation barriers define an isolation zone surrounding the interior region that corresponds with the isolation area around the individual.

Technical effects of apparatuses and methods as described above preferably include the ability to allow individuals to experience new environments or provide such individuals with mobility while maintaining an isolation area around them to reduce the likelihood of the spread of pathogens.

Other aspects and advantages of this invention will be further appreciated from the following detailed description.

### BRIEF DESCRIPTION OF THE DRAWINGS

FIG. 1 represents a first embodiment of an apparatus in accordance with certain nonlimiting aspects of the invention.

FIG. 2 represents a second embodiment of an apparatus in accordance with certain nonlimiting aspects of the invention.

FIG. 3 represents a third embodiment of an apparatus in accordance with certain nonlimiting aspects of the invention.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings. The following detailed description also identifies certain but not all alternatives of the embodiment(s) depicted in the drawings. Therefore, the appended claims, and not the detailed description, are intended to particularly point out subject matter regarded as the invention, including certain but not necessarily all of the aspects and alternatives described in the detailed description.

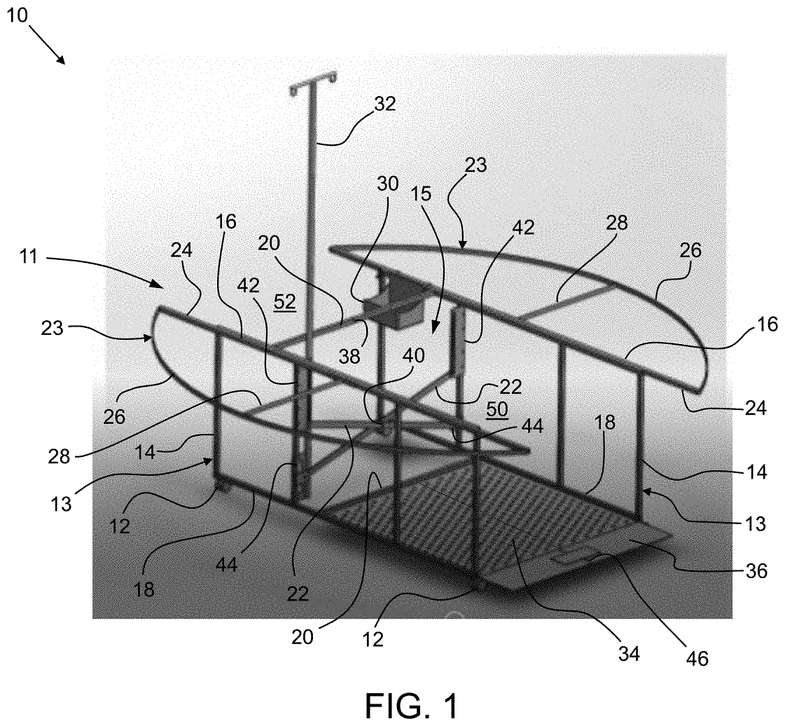

FIGS. 1 through 3 represent various aspects relating to apparatuses suitable for providing mobility for an individual capable of maintaining and/or indicating an isolation zone or area about the individual. The apparatuses are particularly suited for immunocompromised individuals allowing for the individual to move between environments while maintaining a safe distance from other individuals and/or objects. The apparatuses represented in the figures have been tested or otherwise determined to be suitable for allowing immunocompromised children to leave their hospital rooms and interact with other environments and/or individuals while maintaining a predetermined zone or area of isolation, for example, a three-foot (i.e., about one meter) radius surrounding an interior region within the apparatuses within which the individual is positioned and accommodated by structures of the apparatuses.

To facilitate the description provided below of the embodiments represented in the drawings, relative terms, including but not limited to, “vertical,” “horizontal,” “lateral,” “front,” “rear,” “side,” “forward,” “rearward,” “upper,” “lower,” “above,” “below,” “right,” “left,” etc., may be used in reference to an orientation of the apparatuses during their operation, and therefore are relative terms that are useful to describe the apparatuses represented in the drawings, but should not be necessarily interpreted as limitations to the construction and use of the apparatuses.

FIG. 1 schematically represents an apparatus 10 as including a frame 11 supported upon wheels 12 that promote mobility of the frame 11. The frame 11 defines a pair of oppositely-disposed side walls 13 and an interior region 15 within the interior of the apparatus 10 and defined by and between the side walls 13. As will be discussed below, the interior region 15 is sized and spaced to accommodate an individual positioned within the apparatus 10. In the nonlimiting embodiment shown, each side wall 13 includes elongated vertical members 14 and upper and lower horizontal members 16 and 18 between which the vertical members 14 extend. The side walls 13 are coupled to one another by one or more connecting members depicted in the nonlimiting embodiment of FIG. 1 as spanning the interior region 15 of the apparatus 10. In the nonlimiting example of FIG. 1, the connecting members include cross-members 20 that are depicted in FIG. 1 as oriented horizontally and interconnecting the upper and/or lower horizontal members 16 and 18 of one side wall 13 with the upper and/or lower horizontal members 16 and 18 of the other side wall 13. In addition to or as an alternative to the cross-members 20, the connecting members of the frame 11 may include cross-bracing members 22 that define an x-shaped cross brace between the side walls 13. Such cross-bracing members 22 may span between oppositely disposed vertical members 14 on the side walls 13.

The frame 11 of the apparatus 10 includes isolation barriers 23 coupled to the upper horizontal members 16 of the frame 11 and extending in directions outward from the interior region 15 of the frame 11. The isolation barriers 23 define and promote at least a partial isolation area surrounding the interior region 15 of the apparatus 10. In the nonlimiting embodiment shown, the isolation barriers 23 each define a semi-circular area with an outermost radial extent that defines a portion of an outer perimeter of the isolation area. In particular, the isolation barriers 23 each include a curved member 26, a chord member 24 spanning ends of the curved member 26, and one or more brace members 28 between the curved member 26 and the chord member 24. The chord members 24 of the isolation barriers 23 are coupled to the upper horizontal members 16 of the frame 11 and configured to extend horizontally outward from the interior region 15 of the apparatus 10, for example, perpendicular to the vertical members 14 of the frame 11.

In the embodiment represented in FIG. 1, the interior region 15 within the frame 11 of the apparatus 10 is sized and configured to define two separate regions, including a patient area 50 and a caregiver area 52. In the embodiment shown, the interior region 15 and each of the patient and caregiver areas 50 and 52 therein are accessible through openings to the exterior of the frame 11 located between the isolation barriers 23, and the patient and caregiver areas 50 and 52 are separated by at least one of the cross-members 20 and cross-bracing members 22. The patient area 50 is configured to allow an individual, such as an immunocompromised patient, to remain within the interior region 15 of the apparatus 10 such that the isolation barriers 23 define a substantially continuous isolation area around the individual and whose outer extents are a substantially constant distance from the individual. The caregiver area 52 is provided to allow a caregiver, such as a doctor, nurse, therapist, family member, etc., access to the individual for treatment, assistance, or the like while the individual remains within the patient area 50 within the interior region 15 of the apparatus 10. Optionally, either area 50 or 52 within the interior region 15 may include various compartments, shelves, hooks, or other components configured to hold items for the individual or the caregiver. For example, FIG. 1 represents the apparatus 10 as including a storage compartment 30 in the caregiver area 52 and an intravenous (IV) stand 32 for hanging elevated IV bags in the patient area 50.

Optionally, the apparatus 10 may include a raised platform 34 spanning the patient area 50 between the lower horizontal members 18 of the frame 11 as represented in FIG. 1. The platform 34 is configured to support an individual within the patient area 50 both while the apparatus 10 is at rest and while the apparatus 10 is moving. The individual may stand on the platform 34, sit in a wheelchair on the platform 34, or rest in another position as desired. The platform 34 may include an adjustable ramp 36 to provide wheelchair accessibility as represented in FIG. 1. In the nonlimiting embodiment shown, the ramp 36 may be lowered to load a wheelchair thereon and raised to provide clearance when moving the apparatus 10. The presence of the platform 34 is particularly beneficial when the apparatus 10 is used with an individual that is not capable of manually pushing and maneuvering the apparatus 10. In such situations, a caregiver or other individual may push the apparatus 10 from within the caregiver area 52 while the patient remains within the patient area 50 on the platform 34. In other situations in which the individual using the apparatus 10 is independently mobile and capable of pushing and maneuvering the apparatus 10 on their own, the platform 34 may be removed or otherwise omitted from apparatus 10, in which case the patient area 50 is open to ground such that the individual may walk within the patient area 50 while pushing the apparatus 10.

In the nonlimiting embodiment shown in FIG. 1, the apparatus 10 can be configured to fold into a collapsed configuration having a reduced size covering a relatively compact area to provide benefits such as promoting ease of movement around tight corners and through narrow passages, as well as ease of storage. For convenience, the configuration of the apparatus 10 represented in FIG. 1 will be referred to herein as an operational or expanded configuration. For certain nonlimiting embodiments, the apparatus 10 may be folded from the expanded configuration into a collapsed configuration by removing certain components and/or pivoting certain components about respective pivoting joints such that the side walls 13 converge toward one another. For example, the cross-member(s) 20, cross-bracing members 22, and platform 34 may include pivoting joints 38, 40, 42, 44, and 46 as represented in FIG. 1. These components may be pivoted about their respective pivoting joints 38, 40, 42, 44, and 46 such that they fold in a manner that allows the cross-member(s) 20 and the cross-bracing members 22 to extend into the caregiver area 52 and the platform 34 to extend upward within the patient area 50. In addition, the chord members 24 of the isolation barriers 23 may be pivotally coupled to the upper horizontal members 16 such that the isolation barriers 23 are capable of folding downward to be substantially parallel with the side walls 13. In such embodiments, one or more of the pivoting joints 38, 40, 42, 44, and 46 may preferably include locks for maintaining the apparatus 10 in at least the expanded configuration and optionally also the collapsed configuration.

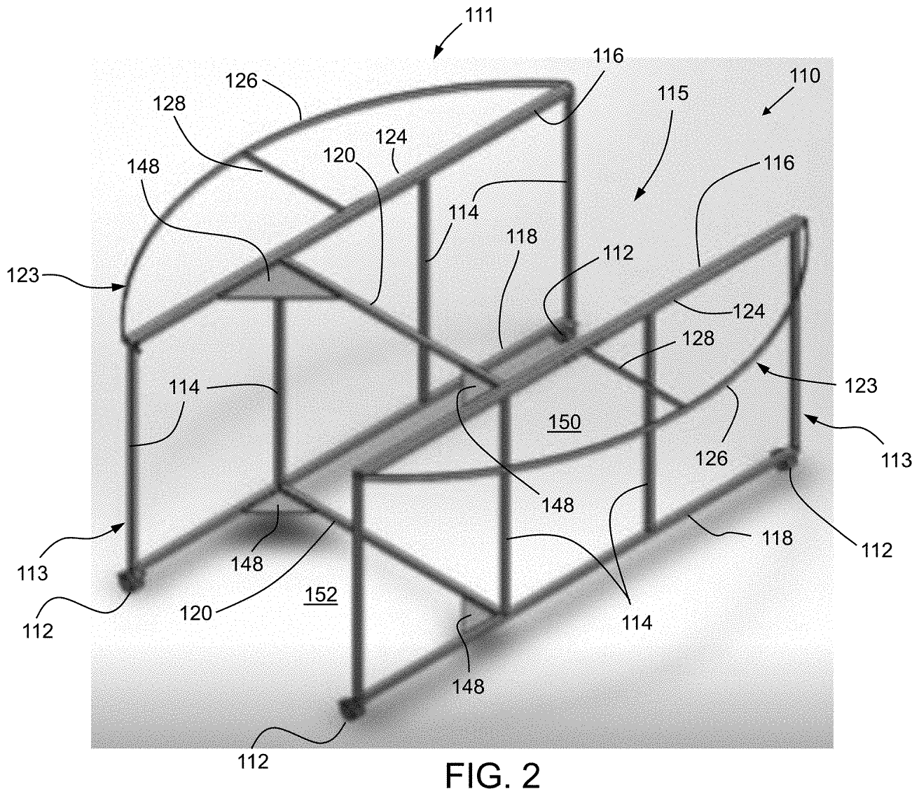

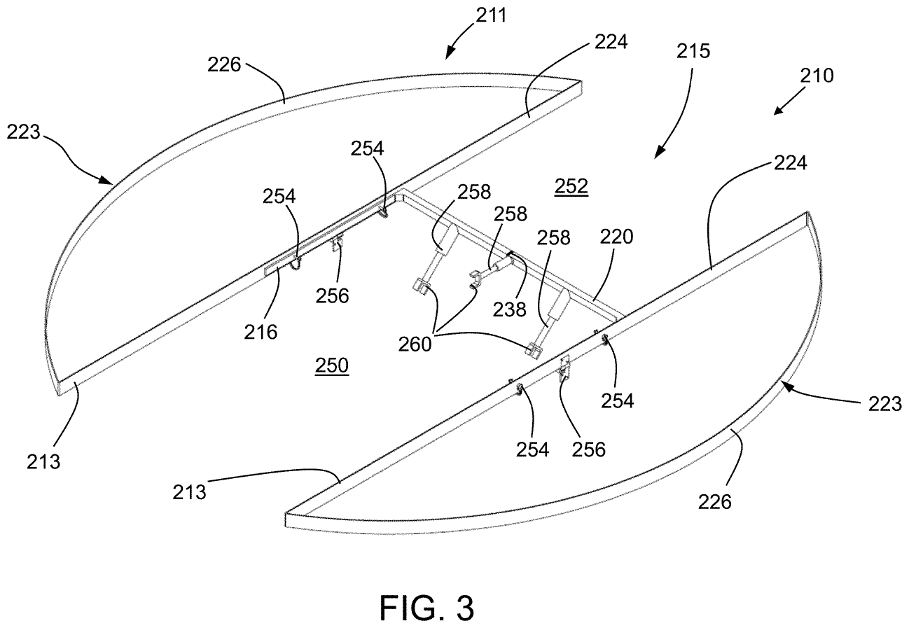

FIGS. 2 and 3 depict additional configurations of apparatuses 110 and 210 in accordance with further embodiments of this invention. In these figures, consistent reference numbers are used to identify the same or functionally related elements, but with a numerical prefix (1 or 2) added to distinguish the particular embodiment from other embodiments of the invention. In view of similarities between the embodiments, the following discussion of FIGS. 2 and 3 will focus primarily on aspects of the further embodiments that differ from the first embodiment in some notable or significant manner. Other aspects of the further embodiments not discussed in any detail can be, in terms of structure, function, materials, etc., essentially as was described for the first embodiment.

FIG. 2 represents the apparatus 110 as having a fixed frame 111 that does not fold into a collapsed configuration from the expanded configuration shown in FIG. 2. The apparatus 110 omits the cross-bracing members 22 and the pivoting joints 38, 40, 42, 44, and 46 of FIG. 1. Instead, the cross-members 120 are reinforced with braces 148 that provide additional rigid support along the upper and lower horizontal members 116 and 118.

FIG. 3 represents the apparatus 210 as having a frame 211 that folds in a manner different from that of FIG. 1. The nonlimiting embodiment of the apparatus 210 comprises at least one U-shaped cross-member 220 whose legs define the horizontal members 216 of the frame 211. The horizontal members 216 are represented as connected to the isolation barriers 223 with combinations of pins 254 and hinges 256, the latter of which enable the isolation barriers 223 to pivot about and downward relative to the horizontal members 216, resulting in the expanded configuration shown in FIG. 3 being converted to a collapsed configuration (not shown). The horizontal members 216 may also be connected with and disconnected from the isolation barriers 223. The pins 254 interconnect and are preferably capable of providing rigid support between the isolation barriers 223 along horizontal members 216 of the frame 211 in order to secure the isolation barriers 223 in both the expanded and collapsed (folded) configurations of the apparatus 210. The cross-member 220 is represented as having a hinge 238 that enables it to be folded, thereby enabling the apparatus 210 to be further collapsed.

Additionally, FIG. 3 represents the cross-member 220 as equipped with extendable arms 258 equipped with clamps 260 adapted to attach to frame members of a wheelchair (not shown). The arms 258 are extendable to account for different sizes and configurations of wheelchairs, as nonlimiting examples, in order to attach to horizontal or vertical bars on the backrest of a wheelchair. In this embodiment, wheels for supporting the frame 211 and enabling the apparatus 210 to be maneuvered on a surface are provided by the wheelchair.

While the invention has been described in terms of specific or particular embodiments, it is apparent that other forms could be adopted by one skilled in the art. For example, For example, the apparatuses 10, 110, and 210 and their components could differ in appearance and construction from the embodiments described herein and shown in the drawings, functions of certain components of the apparatuses 10, 110, and 210 could be performed by components of different construction but capable of a similar (though not necessarily equivalent) function, and various materials could be used in the fabrication of the apparatuses 10, 110, and 210 and/or their components. As such, it should be understood that the intent of the above detailed description is to describe the particular embodiments represented in the drawings and certain but not necessarily all features and aspects thereof, and to identify certain but not necessarily all alternatives to the particular embodiments represented in the drawings. As a nonlimiting example, the invention encompasses additional or alternative embodiments in which one or more features or aspects of a particular embodiment could be eliminated or two or more features or aspects of different described embodiments could be combined. Accordingly, it should be understood that the invention is not limited to any embodiment described herein. It should also be understood that the phraseology and terminology employed above are for the purpose of describing the disclosed embodiments, and do not necessarily serve as limitations to the scope of the invention. Therefore, the scope of the invention is to be limited only by the claims.

1. An apparatus configured to define an isolation area around an individual, the apparatus comprising:
a frame having two opposing and spaced-apart side walls, an interior region within an interior of the apparatus and defined by and between the side walls, and one or more connecting members spanning the interior region and coupling the opposing side walls;
isolation barriers coupled to the frame and extending outwardly from the interior region, the isolation barriers being configured to define an isolation zone surrounding the interior region that corresponds with the isolation area around an individual located within the interior region; and
an opening for providing access for the individual to and from the interior region within the frame.

2. The apparatus of claim 1, further comprising an elevated platform located within the interior region, coupled to the frame, and configured to support the individual while the individual is located in the interior region within the frame.

3. The apparatus of claim 2, further comprising wheels configured to support the frame and enable the frame to be maneuvered on a surface.

4. The apparatus of claim 1, wherein the isolation barriers define outer curved extents defining at least portions of a perimeter of the isolation area.

5. The apparatus of claim 1, wherein the opening is located between a pair of the isolation barriers.

6. The apparatus of claim 1, wherein a patient area and a caregiver area are defined within the interior region and are separated by at least one of the one or more connecting members.

7. The apparatus of claim 1, wherein the one or more connecting members comprise a cross brace between the side walls.

8. The apparatus of claim 1, further comprising one or more storage compartments, bins, shelves, hooks, and hangers coupled to the frame.

9. The apparatus of claim 1, wherein the frame is configured to expand and fold between an expanded configuration and a collapsed configuration, respectively.

10. The apparatus of claim 9, wherein the frame comprises one or more pivoting joints configured to allow the one or more connecting members coupling the side walls to fold such that the side walls converge toward one another.

11. The apparatus of claim 1, further comprising arms mounted to the one or more connecting members that are configured to couple the frame to a wheelchair.

12. A method of defining an isolation area around an individual based on a medical recommendation related to transmission of pathogens to or from the individual, the method comprising:
providing an apparatus comprising a frame having two opposing and spaced-apart side walls, an interior region within an interior of the apparatus and defined by and between the side walls, one or more connecting members spanning the interior region and coupling the opposing side walls, and isolation barriers coupled to the frame and extending outwardly from the interior region; and
locating the individual in the interior region within the frame, the isolation barriers defining an isolation zone surrounding the interior region that corresponds with the isolation area around the individual.

13. The method of claim 12, further comprising maneuvering the apparatus on wheels while the individual remains within the interior region.

14. The method of claim 12, further comprising locating the individual on an elevated platform coupled to the frame and located within the interior region of the frame.

15. The method of claim 14, further comprising lowering a ramp adjacent the opening to provide access to the platform.

16. The method of claim 12, wherein the interior region comprises a patient area and a caregiver area, the method further comprising locating a caregiver within the caregiver area and the caregiver maneuvering the apparatus while the individual is located in the patient area.

17. The method of claim 12, further comprising folding the frame into a collapsed configuration having a reduced surface area coverage.

18. The method of claim 17, wherein folding the frame includes pivoting portions of the frame about one or more pivoting joints such that sides of the frame converge toward one another.

19. The method of claim 18, further comprising clamping to a wheelchair at least one extendable arm that is mounted to the one or more connecting members.
